(19) United States
(12) Patent Application Publication
(10) Pub. No.: US 2015/0310513 A1
(43) Pub. Date: Oct. 29, 2015

(54) UNIT-BASED LICENSING FOR OFFLINE CONTENT ACCESS

(71) Applicant: Altair Engineering, Inc., Troy, MI (US)

(72) Inventors: Massimo Fariello, Turin (IT); Stephanie Scapa, Menlo Park, CA (US)

(21) Appl. No.: 14/698,408

(22) Filed: Apr. 28, 2015

Related U.S. Application Data
(60) Provisional application No. 61/985,268, filed on Apr. 28, 2014.

(51) Int. Cl. G06Q 30/04

(52) U.S. Cl. CPC G06Q 30/04; G06Q 2220/18

(57) ABSTRACT

Offline content access may include receiving, by a server, via an electronic communication link, an offline status message from a customer device associated with a customer account, the offline status message identifying the customer device as an offline device. Offline content access may include receiving, at the server, from the customer device, a request for content. Offline content access may include, on a condition that the customer device is an offline device and on a condition that an electronic communication link between the server and the customer device is available, processing the request as an online content access request, wherein processing the request includes generating a response to the request for content. Offline content access may include transmitting the response to the customer via an electronic communication link.

### CROSS-REFERENCE TO RELATED APPLICATIONS

This application claims priority to U.S. Provisional Patent Application No. 61/985,268, filed on Apr. 28, 2014, which is incorporated by reference in its entirety herein.

### TECHNICAL FIELD

The present disclosure relates to systems and methods of licensing access to content, such as events and digital content.

### BACKGROUND OF THE DISCLOSURE

Digital content such as computer software products, video games, music, and any other media capable of being embodied in digital format may be sold or licensed to an end user customer. For example, the right to copy, access, or execute the digital content may be licensed to a user and a provider or vendor may retain ownership of the rights to the content. Accordingly, it may be desirable to provide unit-based licensing for offline content access.

### SUMMARY OF THE DISCLOSURE

Disclosed herein are aspects, features, elements, implementations, and embodiments of unit-based licensing for offline content access.

In an embodiment, a method of unit-based licensing for offline content access is disclosed. Unit-based licensing for offline content access may include receiving offline content access information, the offline content access information indicating a customer account and content, identifying a cardinality of assigned units for the content, identifying a cardinality of available units allocated to the customer account, determining, by a processor in response to instructions stored on a non-transitory computer readable medium, whether the cardinality of the assigned units is within the cardinality of the available units, and on a condition that the cardinality of the assigned units exceeds the cardinality of the available units, remediating the customer account.

In an embodiment, a method of unit-based licensing for offline content access is disclosed. Unit-based licensing for offline content access may include receiving offline content access information, the offline content access information indicating a customer account and a plurality of content objects, identifying a respective cardinality of assigned units for each content object from the plurality of content objects, identifying a cardinality of available units allocated to the customer account, determining a first subset of content objects from the plurality of content objects such that a sum of the assigned units for the content objects from the first subset of content objects is within the cardinality of the available units, generating an updated cardinality of available units as a difference between the cardinality of the available units and the sum of the assigned units for the content objects from the first subset of content objects, determining a second subset of content objects from the plurality of content objects as a difference between the plurality of content objects and the first subset of content objects, and on a condition that a sum of the assigned units for the content objects from the second subset of content objects exceeds the updated cardinality of available units, remediating, by a processor in response to instructions stored on a non-transitory computer readable medium, the customer account.

In an embodiment, a method of offline content access is disclosed. Offline content access may include receiving, by a server, via an electronic communication link, an offline status message from a customer device associated with a customer account, the offline status message identifying the customer device as an offline device. Offline content access may include receiving, at the server, from the customer device, a request for content. Offline content access may include, on a condition that the customer device is an offline device and on a condition that an electronic communication link between the server and the customer device is available, processing the request as an online content access request, wherein processing the request includes generating a response to the request for content. Offline content access may include transmitting the response to the customer via an electronic communication link.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The description herein makes reference to the accompanying drawings wherein like reference numerals refer to like parts throughout the several views, and wherein:

FIG. 1 is a diagram of an example of a communication system for unit-based licensing for offline content access in accordance with embodiments of this disclosure;

FIG. 2 is a flow diagram of an example of unit-based licensing for digital content access in accordance with embodiments of this disclosure; and

FIG. 3 is a flow diagram of an example of unit-based licensing remediation for offline content access in accordance with embodiments of this disclosure.

### DETAILED DESCRIPTION

A creator or owner of content, such as digital content or live-performance content, may control access to the content by licensing the content to end users. For example, licensing may include controlling the right to access content, which may include controlling the right to display, perform, distribute, or reproduce the content. Content, such as digital content, or live-performance content may be presented at an event, such as a concert, a gallery display, a sporting event, or any multiple access presentation of content. Unit-based licensing may include licensing that controls access to content by allocating licensing units to a customer account, such that one or more licensing units may be redeemed or charged to access one or more events or digital content objects. For example, in some embodiments, a content provider may redeem licensing units and provide content in response to a request for access by a customer.

In some embodiments, a customer, or a portion thereof, may enter an offline state with respect to the content provider and may access one or more events or digital content objects. In some embodiments, the content provider may receive information from the customer indicating one or more content objects accessed offline, and the content provider may remediate the customer based on the offline access.

The aspects, features, elements, and embodiments of methods, procedures, or algorithms disclosed herein, or any part or parts thereof, may be implemented in a computer program, software, or firmware incorporated in a non-transitory computer-readable storage medium for execution by a computer or processor, such as a special purpose computer or processor, and may be implemented as a computer program product, such as a computer program product accessible from a tangible computer-usable or computer-readable medium.

As used herein, the terminology “computer” or “device” includes any unit, or combination of units, capable of performing any method, or any portion or portions thereof, disclosed herein. Devices may further include mobile devices that may include user equipment, a wireless transmit/receive unit, a mobile station, a fixed or mobile subscriber unit, a pager, a cellular telephone, a personal digital assistant (PDA), a computer, or any other type of user device capable of operating in a mobile environment.

As used herein, the terminology “processor” includes a single processor or multiple processors, such as one or more special purpose processors, one or more digital signal processors, one or more microprocessors, one or more controllers, one or more microcontrollers, one or more Application Specific Integrated Circuits (ASICs), one or more Application Specific Standard Products (ASSPs); one or more Field Programmable Gate Arrays (FPGAs) circuits, any other type or combination of integrated circuits (ICs), one or more state machines, or any combination thereof.

As used herein, the terminology “memory” includes any computer-usable or computer-readable medium or device that can, for example, tangibly contain, store, communicate, or transport any signal or information for use by or in connection with any processor. Examples of computer-readable storage mediums may include one or more read only memories, one or more random access memories, one or more registers, one or more cache memories, one or more semiconductor memory devices, one or more magnetic media, such as internal hard disks and removable disks, one or more magneto-optical media, one or more optical media such as CD-ROM disks, and digital versatile disks (DVDs), or any combination thereof.

As used herein, the terminology “example”, “embodiment”, “implementation”, “aspect”, “feature”, or “element” indicate serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terminology “digital content” may include computer software programs, video games, music, movies, videos, or any other media that may be embodied in digital form, and which may be accessed, downloaded, input, or otherwise transferred to a computer or processor. Digital content may include digital data or digital files that may be processed by external application programs or may be executed by external software, hardware, or both. As used herein, the terminology “content” may include live content or fixed content. Fixed content may include any content that may be presented from a tangible storage medium, such as digital content. Live content may include any content that may be accessed substantially concurrently with the creation or generation of the content, such as the presentation of a movie in a movie theater, a concert, a sporting event, or any other live event.

As used herein, the terminology “event” may include any presentation, distribution, or display of content capable of concurrent, or nearly concurrent, access by multiple users. For example, an event may include a physical presentation, such a presentation at a movie theater, concert hall, park, venue, museum, or restaurant, or a virtual presentation, such as a broadcast over the Internet or a television broadcast.

As used herein, the terminology “access” or “accessing” may include presenting, downloading, executing, streaming, or otherwise interacting, or enabling interaction, with content, such as a digital content object or event. In some embodiments, digital content objects may be executed, stored, or both, at a provider location. In some embodiments, digital content objects may be stored locally on a customer network or customer device and the digital content objects may be executed or run on the customer network or device.

In some embodiments, a node based license may indicate that content is accessible by a unique device, such as a computer, a unique account, such as an account associated with an individual user, or a combination of a unique device and a unique account. In some embodiments, a network based license may indicate that content is accessible by one or more devices within a specified network. For example, a defined number of devices within the network may concurrently access the content. In some embodiments, a license, including a node based license or a network based license, may be associated with a unique content object or event, or with a suite of related content objects and events.

As used herein, the terminology “assigned units”, “price”, “licensing price” or variations thereof, may include an assigned number of licensing units that may be exchanged or redeemed to access content, such as a particular event or digital content object. As used herein, the terminology “licensed units” or “allocated units” may refer to a total number of units provided to a customer or customer group. As used herein, the terminology “checked out units”, “redeemed units”, or “exchanged units” may refer to assigned units charged to a customer for content, such as events or digital content being accessed. “Available units” may refer to a difference between licensed units and checked out units. In some embodiments, licensing units may be temporarily or permanently exchanged for access. Temporarily exchanged licensing units may be returned to the pool of available units associated with the customer upon termination or completion of content access. Returned units may be included in the available units allocated to the customer and may be redeemed for access to other content, such as events or digital content.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

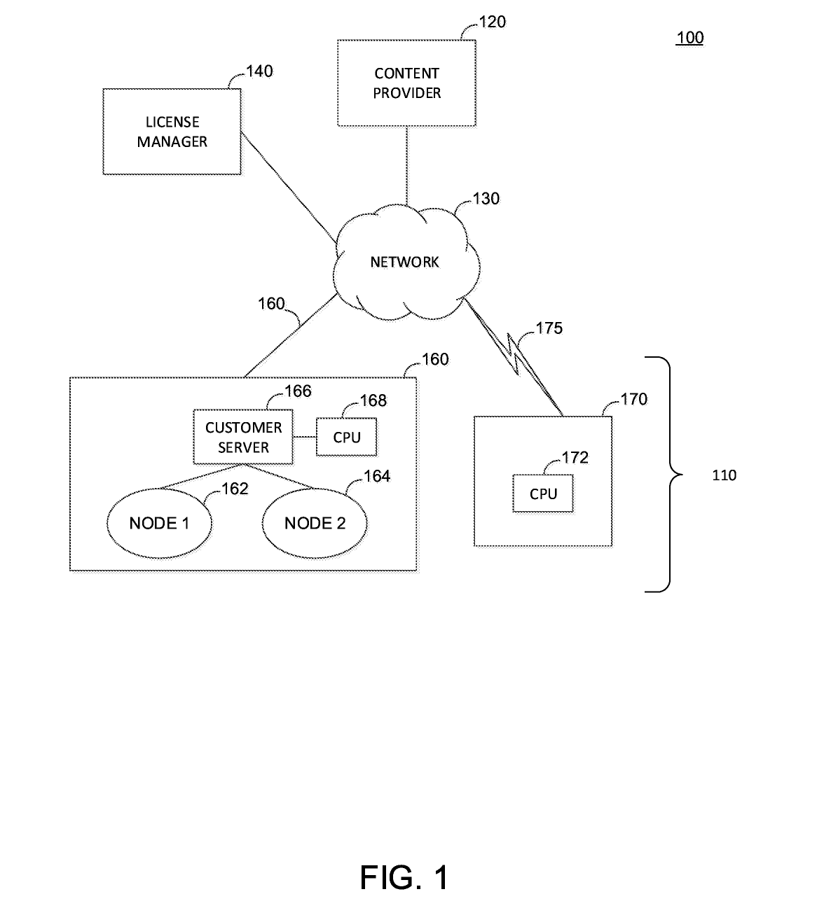

FIG. 1 is a diagram of an example of a communication system 100 for unit-based licensing for content access in accordance with embodiments of this disclosure. For simplicity, the communication system 100 shown in FIG. 1 includes a customer system 110, a provider 120, a network 130, and a license manager 140; however, other elements, such as multiple networks, access points, or communication mediums may be included in a communication system for unit-based licensing for content access.

In some embodiments, customer system 110 may be associated with an individual user or customer, and the user may access content, such as events or digital content, using licensing units allocated to the user or to an account representing the user. In some embodiments, customer system 110 may comprise devices and networks through which a customer or user may access digital content from provider 120, or register for, or access, events. For example, as shown in FIG. 1, customer system 110 may include a customer network 160 and a customer device 170; however, any number of customer networks and customer devices may be used.

In some implementations, customer system 110 may be associated with a collection or group of customers, or members, and shared licensing units may be allocated to the group. For example, a group may include one or more families, a classroom of students, a small business, a social group, or any other organization capable of licensing content, such as events or digital content, such that members of the group are capable of accessing the content, such as events or digital content.

In some embodiments, elements of the customer system 110, such as customer network 160 and customer device 170, may communicate with each other or with elements external to the customer system 110, such as the provider 120. For example, customer network 160 and customer device 170 may independently communicate through communication network 130.

In some embodiments, customer network 160 may include one or more individual nodes 162/164, a customer server 166, a host processor (CPU) 168, or any combination thereof. A node 162/164 may be a device, such as a computer, and may access digital content. For example, a node 162/164 may access digital content in response to user input. Although FIG. 1 includes a first node 162 and a second node 164 for simplicity, any number of nodes may be used. In some embodiments, a node 162/164 may be connected to a customer server 166 and may have a unique network address. In some embodiments, a node 162/164 may communicate with other nodes 162/164 within customer network 160. The customer server 166 may communicate with CPU 168. Although individual nodes 162/164 are depicted as being connected in a spoke configuration to the customer server 166, the individual nodes 162/164 may be connected in any other electronic computer network configuration. Although shown as separate units, in some embodiments, customer server 166 and CPU 168 may be combined into a single device.

In some embodiments, customer device 170 may be any device, such as a computer or mobile device, capable of accessing digital content. In some embodiments, a customer device 170 may include a processor, such as CPU 172.

In some embodiments, provider 120 may be a device or system configured to provide access to digital content to one or more licensed customers. For example, provider 120 may include an Internet Protocol (IP) network-based unit, such as a website service, that implements methods for controlling access to content, such as events or digital content. In some embodiments, provider 120 may provide customer system 110 access to digital content objects, which may be included in a suite of digital content. In some embodiments, provider 120 may be any system configured to control access to or registration for events by licensed customers. Although FIG. 1 shows the provider 120 as a single unit, the provider 120 may include any number of discrete units and any number of providers 120 may be used.

In some embodiments, the provider 120 may include an event provider (not shown separately) and may control access to or registration for one or more events. The event provider may be any system configured to receive a request to access or register for an event and output a response indicating whether access or registration is granted. In some embodiments, the request for access may include a request to register for the event, which may include receiving registration information. In some embodiments, the event provider may be the provider 120. In some embodiments, event provider may be separate from provider 120. Although shown as a single unit in FIG. 1, in some embodiments, the provider 120 may include a content provider as a first unit and the event provider as a second unit. For example, the content provider and the event provider may be independent units within a single physical device, or may be independent physical devices.

In some implementations, unit-based licensing for content may include communication between the customer system 110 and the provider 120 via the communication network 130. The communication network 130 may be a local area network (LAN), wide area network (WAN), virtual private network (VPN), a mobile or cellular telephone network, the Internet, or any other electronic communication medium. Although not explicitly shown in FIG. 1, each of the customer system 110, provider 120, and license manager 140 may communicate with communication network 130 through one or more Internet service providers (ISPs). In some embodiments, the customer network 160, the customer device 170, or both, may communicate with the network 130 via a wired connection 165 a wireless connection 175, or a combination of one or more wired or wireless connections.

In some embodiments, a license manager (LM) 140 may be included in the communication system 100. License manager 140 may control the access to content, such as events, digital content, or both, provided by provider 120. Although shown as a separate unit, in some embodiments, license manager 140 may be incorporated with provider 120, customer system 110, or both. In some embodiments, the license manager 140 may monitor content access for the customer system 110. For example, the license manager 140 may detect the termination or conclusion of access to content.

In some embodiments, license manager 140 may generate and maintain a log. The log may include a record of a number of available units that may be used by the customer system 110 at any given time. In some embodiments, the license manager 140 may update the log for each change of the available units for customer system 110. For example, the log may be updated to indicate a change in the available units in response to the accessing of content, such as events or digital content, from provider 120, the termination of the access of content, such as events or digital content, or a change in pricing of content, such as events or digital content, being accessed by the customer. In some embodiments, the log may be a file, or database, stored in a memory in communication with provider 120 or license manager 140.

Although not shown in FIG. 1, in some embodiments, communication system 100 may include a registration unit. In some embodiments, a registration unit may be a device, such as a computer. For example, the registration unit may be a kiosk physically located at an event location. In some embodiments, the registration unit may be configured to receive registration information. For example, the registration unit may include a user interface device, such as a keyboard or touchscreen, and may receive user input indicating registration information via the user input device. In some embodiments, the registration unit may communicate with a user device, such as customer device 170.

In some embodiments, unit-based licensing for content access may include controlling access to content in response to a request to access the content from a customer system.

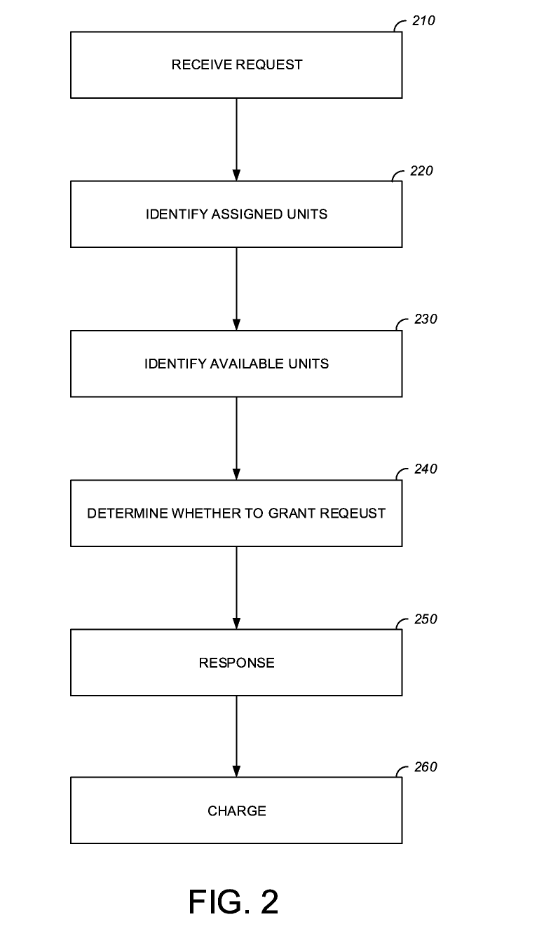

FIG. 2 is a flow diagram of an example of unit-based licensing for content access in accordance with embodiments of this disclosure. Unit-based licensing for content access may include temporarily or permanently exchanging licensing units for access to content, such as digital content or event content. In some embodiments, unit-based licensing for content access may be implemented in a communication system, such as the communication system 100 shown in FIG. 1.

In some embodiments, unit-based licensing for content access may include receiving a request to access content, such as an event or digital content object, at 210, identifying an amount of assigned units for the content at 220, identifying an amount of available units 230, determining whether to grant the request at 240, responding to the request at 250, or a combination thereof.

In some embodiments, a request to access content may be received at 210. For example, a provider, such as the provider 120 shown in FIG. 1, may receive the request from a customer, such as the customer system 110 shown in FIG. 1. In some embodiments, the request may indicate a selected content, such as an event or digital content object. In some embodiments, the request to access content may include information identifying the customer, such as account information associated with the customer system.

In some embodiments, assigned license units for the selected content may be identified at 220. In some embodiments, the number of assigned units for content, such as an event or digital content object, may remain constant or may vary over time. In some embodiments, a license manager, such as the license manager 140 shown in FIG. 1, may identify the assigned license units for the selected content. In some embodiments, the license manager may be independent of the provider, and the license manager may receive the request from the customer system via the network or via the provider.

In some embodiments, a number or cardinality of available units associated with the customer system may be determined at 230. The available units may indicate a number of licensing units that may be used by the customer system at a given time, such as at the time the request is received. For example, although not shown in FIG. 2, one or more licensing units may be allocated or licensed to the customer system, one or more of the allocated units may be temporarily or permanently exchanged or checked out for access to content, and the number of available units may indicate the difference between the number of allocated units and the number of checked out units.

In some embodiments, whether to grant access may be determined at 240. For example, determining whether to grant access at 240 may be based on the count of available units for the customer, the count of checked out units for the customer, the number of assigned units for the content, or a combination thereof. For example, determining whether to grant access at 240 may include determining whether the count of available units for the customer is equal to or greater than the number of assigned units for the content.

In some embodiments, determining whether to grant access at 240 may include determining the number of available licensing units allocated to the customer system to charge against the customer system for access to the selected content. In some embodiments, the provider or the licensing manager may determine the number of checked out units currently charged against the customer system, and may determine a number of licensing units to charge against the customer system based on a difference between the number of assigned units for the requested content and the number of currently checked out units for the customer. For example, the number of currently checked out units for the customer may be greater than the number of assigned units, the request may be granted and the number of units to charge against the customer system may be zero. In another example, the number of currently checked out units for the customer may be less than the number of assigned units, the request may be granted, and the number of units to charge against the customer system may be equal to the difference between the number of assigned units and the number of currently checked out units.

In some embodiments, a response may be output at 250. For example, the provider or licensing manager may generate a response indicating that the request for access is granted or denied and may transmit the response to the customer system. In some embodiments, the request for access may be denied. For example, the number of available units associated with the customer may be less than the number of assigned units for the requested content and the request may be denied. In some embodiments, the provider may reject the request and may prevent the customer system from accessing to the content. In some embodiments, the request for access may be granted. For example, the number of available units associated with the customer may be equal to or greater than the number of assigned units for the requested content and the request may be granted.

In some embodiments, a number of available licensing units allocated to the customer system may be charged to the customer system at 260. In some embodiments, the customer system may be charged in response to granting the request for access. In some embodiments, the customer system may be charged in response to receiving the content at the customer system from the provider. In some embodiments, the customer system may be charged in response to accessing the content by one or more customer devices or nodes in the customer system.

In some embodiments, charging the customer system may include recording the number of licensing units charged, updating the number available units associated with the customer system, or both. In some embodiments, the license manager or provider may record any change in charged units or available units in a log. In some embodiments, the number of available units for the customer system may be decreased in an amount equal to the number of assigned units for the content indicated in the request.

In some embodiments, charging the customer system at 260 may include receiving information indicating that a customer device or node is accessing the requested content. For example, the content may be accessed from the provider in response to outputting the response at 250.

In some embodiments, the requested content may be available at the customer system, may be accessed online or offline, and charging the customer system at 260 may be performed in response to one or more customer devices, such as the customer device 170 shown in FIG. 1, or nodes, such as the nodes 162/164 shown in FIG. 1, accessing the content.

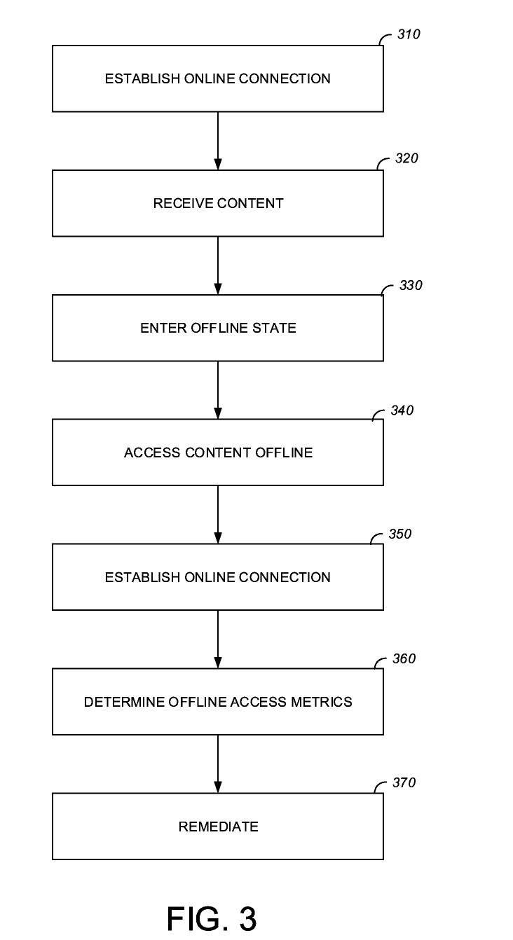

FIG. 3 is a flow diagram of an example of unit-based licensing remediation for offline content access in accordance with embodiments of this disclosure. In some embodiments, content may be accessed offline and charging the customer for access, such as the charging shown at 260 in FIG. 2, may be performed asynchronously with the related access. In some embodiments, unit-based licensing remediation for offline content access may include establishing an online connection at 310, receiving content at 320, entering an offline state at 330, accessing content at 340, establishing an online connection at 350, determining offline access metrics at 360, remediating licensing at 370, or a combination thereof.

In some embodiments, an online connection may be established at 310. For example, the customer system, or an element thereof, such as a customer device, may establish a communication link with the provider via the network.

In some embodiments, the customer system, or an element thereof, such as a customer device, may receive content at 320. For example, the customer system may receive the content from the provider. In some embodiments, receiving content may include copying, installing, storing, or otherwise manipulating the content independently of accessing the content. In some embodiments, receiving the content at 320 may include receiving content identified for offline access. In some embodiments, receiving the content at 320 may include checking out one or more licensing units for the customer. For example, a number of licensing units associated with the content may be checked out.

In some embodiments, the customer system, or an element thereof, may enter an offline state with respect to the provider, the licensing manager, or both, at 330. In some embodiments, entering an offline state with respect to the provider may include entering an offline state with respect to external entities other than the provider or licensing manager. For example, the customer device may disconnect from one or more networks. Although described as an offline state, in some embodiments, the customer system may be online with respect to external entities other than the provider or licensing manager.

Although not shown separately in FIG. 3, in some embodiments, entering the offline state at 330 may include determining whether to enter the offline state. In some embodiments, determining whether to enter the offline state may include generating and sending a request to enter the offline state. For example, the customer system may generate a request to enter an offline state and may send the request to enter the offline state to the provider, the licensing manager, or both. In some embodiments, determining whether to enter the offline state may include receiving a response granting, or denying, a request to enter the offline state. For example, the customer system may receive a response granting, or denying, a request to enter an offline state from the provider, the licensing manager, or both. In some embodiments, the customer system, the provider, the licensing manager, or a combination thereof may identify a number of available offline devices for the customer, which may be based on a difference between a maximum number of offline devices for the customer and a number of currently offline devices for the customer. In some embodiments, the maximum number of offline devices for the customer may be based on the number of number of licensing units allocated to the customer. In some embodiments, the customer system, or a portion thereof, such as a customer device, may enter the offline state in response to determining that there the number of available offline devices is at least one. In some embodiments, the number of available offline device may be less than one and the customer device may omit entering the offline state.

In some embodiments, entering an offline state with respect to the provider may include setting one or more indicators, such as a flag. For example, the provider, the licensing manager, or both, may maintain one or more state indicators, such as an offline state indicator, for a customer system, or for one or more portions of a customer system.

In some embodiments, entering an offline state at 330 may be independent of a communication connection or link, such as the communication link established at 310, between the customer system, or device, and the provider or licensing manager. For example, although not shown separately in FIG. 3, a customer device may enter an offline state at 300, may maintain the communication link established at 310, and may perform online content access, such as the content access shown in FIG. 2.

In some embodiments, entering the offline state at 330 may include checking out one or more licensing units for the customer. For example, the provider, the licensing manager, or both may determine that the customer system entered an offline state with the content received at 320 available in the offline state and a number of licensing units, such as a number of licensing units associated with the content may be checked out. In some embodiments, the number of licensing units checked out may be a number associated with offline access for the customer, such as a number received as input from the customer.

In some embodiments, content may be accessed offline at 340. For example, the digital content may be software installed on the customer device, the customer device may enter an offline state, and the software may be accessed, or executed, offline. In another example, the digital content may be a media file stored on the customer network, a node in the customer network may be in an offline state with respect to the provider and the licensing manager, and the media file may be accessed, or presented, offline. As used herein, the terminology “accessed offline” or “offline access” includes accessing any content, including event content or digital content, by any entity or device wherein the number of assigned units for the content is not synchronously charged to the customer.

In some embodiments, accessing content offline at 340 may include accessing content in an offline state independent of the availability or use of a connection or link between the customer network or device and the provider or licensing manager. For example, a customer device may enter an offline state at 330 and access content offline at 340 independent of whether a connection or link between the customer device and the provider or licensing manager is available.

In some embodiments, accessing content offline at 340 may include accessing content in an offline state when a connection or link between the customer network or device and the provider or licensing manager is unavailable. For example, a customer device may enter an offline state at 330, may determine that a connection or link between the customer device and the provider or licensing manager is available (not shown), may access content online (not shown), may subsequently determine that a connection or link between the customer device and the provider or licensing manager is unavailable (not shown), and may access content offline at 340.

In another example, the provider, the licensing manager, or a combination thereof may receive an offline status message from a customer device. The offline status message may indicate that the customer device is in an offline state. An electronic communication link may be available between the provider, the licensing manager, or a combination thereof, and the offline customer device. The provider, the licensing manager, or a combination thereof, may receive a request for content from the offline customer device via the electronic communication link, and may process the request as an online content access request. In some embodiments, the offline status message may include an offline status request.

In some embodiments, offline access at 340 may be denied. For example, a customer may receive content having an assigned number of licensing units at 320, the customer system may check out a number of licensing units associated with offline access at 330, the number of licensing units associated with offline access may be less than the number of licensing units assigned to the content, and access to the content may be denied at 340. In some embodiments, offline access at 340 may be denied based on recency. For example, access to content received at 320 may be denied after a period of time, such as 30 days from receiving the content, has expired.

In some embodiments, an online connection may be established at 350. For example, the customer system may establish a communication link with the provider, the licensing manager, or both, via the network.

In some embodiments, offline access metrics may be determined at 360. For example, the licensing manager, the provider, or both, may receive information from the customer system indicating offline content access. In some embodiments, the offline content access information may include information identifying one or more digital content objects. In some embodiments, offline content access information may include information indicating a device, a user, or both, associated with accessing the content. In some embodiments, the offline content access information may include temporal information, such as a time and date stamp, associated with each respective incident of content access. In some embodiments, the offline content access information may include an indicator, such as a flag, indicating whether the customer device is associated with an offline state.

In some embodiments, determining the offline access metrics at 360 may include determining cumulative, or peak, content access information. For example, the licensing manager may determine the number of licensing units assigned for each digital content object at the time the respective content was accessed and may determine the maximum number of licensing units assigned to concurrently accessed content.

In some embodiments, licensing units may be remediated at 370. In some embodiments, remediating licensing units may include charging the total number of assigned units associated with content accessed offline or the peak number of licensing units associated with content accessed offline, to the customer.

In some embodiments, the number of assigned units associated with content accessed offline may exceed the number of licensing units allocated to the customer and remediation may include, for example, accelerating a payment for the customer. For example, the customer may have a recurring billing period, such as a regular monthly payment scheduled for the first day of the month, the customer may exceed the number of allocated units in a month, and remediation may include adjusting the next payment date forward in proportion to the difference between the allocated units for the customer and the number of assigned units associated with content accessed offline. In another example, the number of units allocated to the customer in the following month may be reduced by the number of overage units for the current month. In some embodiments, remediation may include charging the customer an offline use overage fee, such as a specified amount, an amount proportional to the number of licensing units used offline in excess of the number of licensing units allocated to the customer, an amount proportional to the number of content objects accessed offline in excess of the number of licensing units allocated to the customer, or a combination thereof.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method comprising:
receiving offline content access information, the offline content access information indicating a customer account and content;
identifying a cardinality of assigned units for the content;
identifying a cardinality of available units allocated to the customer account;
determining, by a processor in response to instructions stored on a non-transitory computer readable medium, whether the cardinality of the assigned units is within the cardinality of the available units; and
on a condition that the cardinality of the assigned units exceeds the cardinality of the available units, remediating the customer account.

2. The method of claim 1, wherein remediating the customer account includes accelerating a payment associated with the customer account.

3. The method of claim 1, wherein remediating the customer account includes transferring an available unit for a subsequent billing period for the customer account to a current billing period for the customer account.

4. The method of claim 1, wherein remediating the customer account includes charging the customer account a specified fee.

5. The method of claim 1, wherein remediating the customer account includes:
determining an overage fee proportional to a difference between the cardinality of the assigned units and the cardinality of the available units; and
charging the customer account the overage fee.

6. The method of claim 1, wherein the content includes a plurality of content objects and wherein identifying the cardinality of assigned units includes:
identifying a respective cardinality of assigned units for each content object from the plurality of content objects, and wherein remediating the customer account includes:
determining a first subset of content objects from the plurality of content objects such that a sum of the assigned units for the content objects from the first subset of content objects is within the cardinality of the available units;
determining a second subset of content objects from the plurality of content objects as a difference between the plurality of content objects and the first subset of content objects;
determining a cardinality of the second subset of content objects; and
determining an overage fee proportional to the cardinality of the second subset of content objects; and
charging the customer account the overage fee.

7. The method of claim 1, further comprising:
receiving a request to enter an offline state, the request to enter the offline state indicating the customer account and a device identifier;
determining a cardinality of available offline devices associated with the customer account;
on a condition that the cardinality of available offline devices is at least one, transmitting a response indicating that the request to enter the offline state is granted; and
on a condition that the cardinality of available offline devices is less than one, transmitting a response indicating that the request to enter the offline state is denied.

8. The method of claim 7, wherein determining the cardinality of available offline devices includes:
identifying a maximum cardinality of offline devices for the customer account;
identifying a cardinality of devices associated with the customer account in the offline state; and
determining the cardinality of available offline devices as a difference between the maximum cardinality of offline devices for the customer account and the cardinality of devices associated with the customer account in the offline state.

9. The method of claim 8, wherein identifying the maximum cardinality of offline devices is based on a cardinality of units allocated to the customer account.

10. The method of claim 7, further comprising:
in response to transmitting the response indicating that the request to enter the offline state is granted, updating the cardinality of available offline devices.

11. A method comprising:
receiving offline content access information, the offline content access information indicating a customer account and a plurality of content objects;
identifying a respective cardinality of assigned units for each content object from the plurality of content objects;
identifying a cardinality of available units allocated to the customer account;
determining a first subset of content objects from the plurality of content objects such that a sum of the assigned units for the content objects from the first subset of content objects is within the cardinality of the available units;
generating an updated cardinality of available units as a difference between the cardinality of the available units and the sum of the assigned units for the content objects from the first subset of content objects;
determining a second subset of content objects from the plurality of content objects as a difference between the plurality of content objects and the first subset of content objects; and
on a condition that a sum of the assigned units for the content objects from the second subset of content objects exceeds the updated cardinality of available units, remediating, by a processor in response to instructions stored on a non-transitory computer readable medium, the customer account.

12. The method of claim 11, wherein remediating the customer account includes accelerating a payment associated with the customer account.

13. The method of claim 11, wherein remediating the customer account includes transferring an available unit for a subsequent billing period for the customer account to a current billing period for the customer account.

14. The method of claim 11, wherein remediating the customer account includes:
determining an overage fee proportional to a difference between the sum of the assigned units for the content objects from the second subset of content objects and the updated cardinality of available units; and
charging the customer account the overage fee.

15. The method of claim 11, further comprising:
receiving a request to enter an offline state, the request to enter the offline state indicating the customer account and a device identifier;
determining a cardinality of available offline devices associated with the customer account;
on a condition that the cardinality of available offline devices is at least one, transmitting a response indicating that the request to enter the offline state is granted; and
on a condition that the cardinality of available offline devices is less than one, transmitting a response indicating that the request to enter the offline state is denied.

16. The method of claim 15, wherein determining the cardinality of available offline devices includes:
identifying a maximum cardinality of offline devices for the customer account;
identifying a cardinality of devices associated with the customer account in the offline state; and
determining the cardinality of available offline devices as a difference between the maximum cardinality of offline devices for the customer account and the cardinality of devices associated with the customer account in the offline state.

17. The method of claim 16, wherein identifying the maximum cardinality of offline devices is based on a cardinality of units allocated to the customer account.

18. The method of claim 15, further comprising:
in response to transmitting the response indicating that the request to enter the offline state is granted, updating the cardinality of available offline devices.

19. A method comprising:
receiving, by a server, via an electronic communication link, an offline status message from a customer device associated with a customer account, the offline status message identifying the customer device as an offline device;
receiving, at the server, from the customer device, a request for content;
on a condition that the customer device is an offline device and on a condition that an electronic communication link between the server and the customer device is available, processing the request as an online content access request, wherein processing the request includes generating a response to the request for content; and
transmitting the response to the customer via an electronic communication link.

20. The method of claim 19, wherein processing the request includes:
identifying a cardinality of assigned units for the content;
identifying a cardinality of available units allocated to the customer account;
determining whether the cardinality of the assigned units for the content is within the cardinality of the available units;
on a condition that the cardinality of the assigned units for the content exceeds the cardinality of the available units, transmitting a response denying the content access request; and
on a condition that the cardinality of the available units exceeds the cardinality of the assigned units for the content, generating an updated cardinality of the available units as a difference between the cardinality of the available units and the cardinality of the assigned units for the content, and transmitting a response granting the content access request.
